(19) United States
(12) Patent Application Publication
(10) Pub. No.: US 2011/0078655 A1
(43) Pub. Date: Mar. 31, 2011

(54) CREATING FUNCTIONAL EQUIVALENT CODE SEGMENTS OF A COMPUTER SOFTWARE PROGRAM WITH LOWER ENERGY FOOTPRINTS

(75) Inventors: Arnon Amir, San Jose, CA (US); Nimrod Megido, San Jose, CA (US)

(73) Assignee: INTERNATIONAL BUSINESS MACHINES CORPORATION, Armonk, NY (US)

(21) Appl. No.: 12/571,353

(22) Filed: Sep. 30, 2009

(51) Int. Cl. G06F 9/44

(52) U.S. Cl. 717/106

(57) ABSTRACT

The present invention provides a method and system of creating at least one functional equivalent code segment of at least one original code segment of a computer software program with a lower energy footprint, configured to operate on at least one computer system. In an exemplary embodiment, the method and system include (1) creating at least one alternative code segment of the original code segment using at least one re-coding rule, (2) calculating a required energy consumption of the original code segment, (3) finding a required energy consumption of the alternative code segment, (4) comparing the required energy consumption of the original code segment with the required energy consumption of the alternative code segment, and (5) returning the functional equivalent code segment corresponding to the code segment with the minimum required energy consumption with respect to the results of the comparing.

### FIELD OF THE INVENTION

The present invention relates to computer systems, and particularly relates to a method and system of creating at least one functional equivalent code segment of at least one original code segment of a computer software program with a lower energy footprint, configured to operate on at least one computer system.

### BACKGROUND OF THE INVENTION

In the recent years, government incentives, emerging business models, and an awakening consciousness regarding the global environment has stewarded renewed interest, at least in corporations, in creating and implementing environmentally friendly saving initiatives throughout their organizations. In the information technology field, this effort has centered around reducing the energy consumption needs for the computer software programs and computer systems that are the backbone of information processing infrastructures.

### Energy of Computer Software Code

To date, very little emphasis has been placed on the energy of computer software code. The energy of computer software code is the energy consumed when the piece of code is run on a particular piece of data on a particular computer system.

A computer system typically has a platform map. A platform map is a lookup table of the basic assembly language commands supported by the computer system in question (which is normally based on the chip and/or motherboard of the computer system) and the energy consumption needs of each of the commands. In other embodiments of this invention, the Platform Map is provided by the chipset or motherboard manufacturer.

### PRIOR ART SYSTEMS

### Green Hardware Solution

One prior art system is a Green Hardware Solution (GHS). A GHS focuses on manipulating the power consumption of devices, irrespective of the applications being executed on the devices. A GHS system would typically make such a device go into standby mode after a set number of minutes of idle time and switching monitor intensity to the bare minimum. GHSs are targeted at particular devices that follow a specific manufacturing process and whose characteristics are known to the GHS maker.

An example of a GHS system are Transmeta techniques for lowering hardware power by manipulating the hardware. The techniques entail a “suite of advanced power management, leakage control and process compensation technologies that can diminish the negative effects of increasing power and process variations in advanced semiconductor designs.” Transmeta “provides supporting hardware blocks to enable rapid adoption of LongRun2 Technology into either existing designs or new designs.” “Active power is the amount of power a semiconductor device consumes during operation and is a combination of dynamic power and leakage power. While the leakage component was negligible in the 130 nm generation and prior, it is a significant component of power in 90 nm and finer geometries. LongRun2 Technology can reduce both the worst case active power as well as the nominal (or average) power consumption.” (See TransMeta LongRun2 Power Management Technology.)

Green Software Solution

Another prior art system is a Green Software Solution (GSS). A GSS focuses on reducing the power footprint of a computer software program to be executed. GSSs are targeted at all programs running on particular families of computer instruction sets.

One example of a GSS system is a “reduce power for laptop” tool. A “reduce power for laptop” tool focuses on strategies for manipulating the power states of a device in/on a computer system. Ultimately, a “reduce power for laptop” tool focuses on hardware management strategies, such as finding a (minimal) balance between switching power and leakage power or strategies for lowering standby power.

Another example of a GSS system is Dynamically Architected Instruction Set from Yorktown (DAISY). DAISY addresses the issue of lack of compatibility between VLIW (Very long Instruction Word) architectures and more popular architectures (e.g., PowerPC, Intel x86). DAISY works as follows: “Each time a new fragment of code (such as a page) is executed for the first time, the code is translated to simple RISC-like primitives, parallelized and saved in a portion of main memory not visible to the old architecture. Subsequent executions of the same fragment do not require a translation (unless cast out)”. DAISY “includes new fast compiler algorithms for accomplishing the dynamic translation and parallelization across multiple paths and loop iteration boundaries”. (See IBM TJ Watson Research Center, Dynamically Architected Instruction Set from Yorktown (DAISY) Research Report.) Namely,

Referring to FIG. 1, a prior art GSS DAISY system includes a DAISY translator 112 and DAISY hardware 114. As depicted in FIG. 1, DAISY translator 112 translates a fragment of code (e.g., a page) into Reduced Instruction Set Computer (RISC)-like primitives for execution by DAISY hardware 114.

Therefore, a method and system of creating at least one functional equivalent code segment of at least one original code segment of a computer software program with a lower energy footprint, configured to operate on at least one computer system, is needed.

### SUMMARY OF THE INVENTION

The present invention provides a method and system of creating at least one functional equivalent code segment of at least one original code segment of a computer software program with a lower energy footprint, configured to operate on at least one computer system. In an exemplary embodiment, the method and system include (1) creating at least one alternative code segment of the original code segment using at least one re-coding rule, (2) calculating a required energy consumption of the original code segment, (3) finding a required energy consumption of the alternative code segment, (4) comparing the required energy consumption of the original code segment with the required energy consumption of the alternative code segment, and (5) returning the functional equivalent code segment corresponding to the code segment with the minimum required energy consumption with respect to the results of the comparing. In an exemplary embodiment, the present invention further includes providing the difference between a required energy consumption of the functional equivalent code segment and the required energy consumption of the original code segment.

In an exemplary embodiment, the calculating includes (a) rewriting the original code segment into at least one computer instruction executable by the computer system, (b) determining the amount of energy required to be consumed for performing the instruction on the computer system, and (c) providing the required energy consumption of the original code segment based on the determining. In an exemplary embodiment, the rewriting includes converting the original code segment into at least one assembly language instruction executable by the computer system. In an exemplary embodiment, the determining includes determining the amount of energy required to be consumed for performing the instruction on the computer system from a platform map for the computer system.

In an exemplary embodiment, the finding includes (a) rewriting the alternative code segment into at least one computer instruction executable by the computer system, (b) determining the amount of energy required to be consumed for performing the instruction on the computer system, and (c) providing the required energy consumption of the alternative code segment based on the determining. In an exemplary embodiment, the rewriting includes converting the alternative code segment into at least one assembly language instruction executable by the computer system. In an exemplary embodiment, the determining includes determining the amount of energy required to be consumed for performing the instruction on the computer system from a platform map for the computer system.

### THE FIGURES

FIG. 1 is a diagram of a prior art technique.

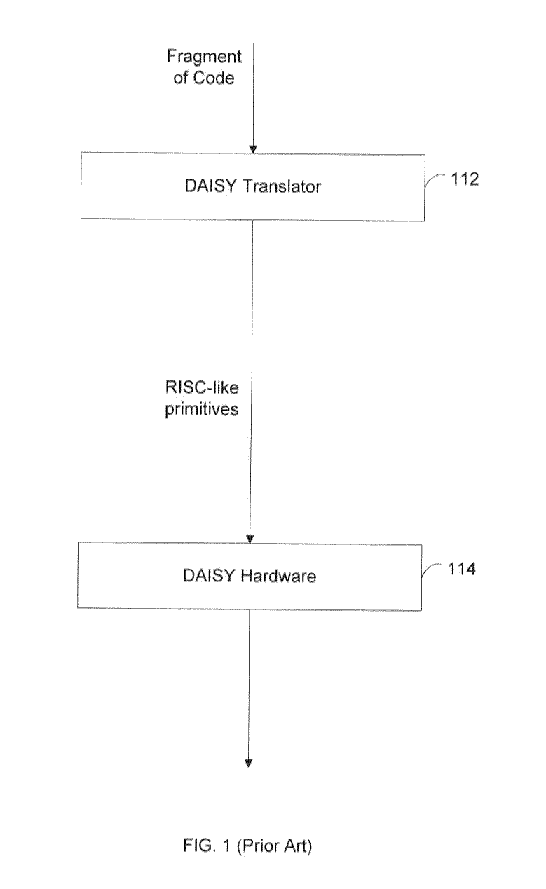

FIG. 2A is a flowchart in accordance with an exemplary embodiment of the present invention.

FIG. 2B is a flowchart in accordance with an exemplary embodiment of the present invention.

FIG. 2C is a diagram in accordance with an exemplary embodiment of the present invention.

FIG. 3 is a flowchart of the calculating step in accordance with an exemplary embodiment of the present invention.

FIG. 4 is a flowchart of the rewriting step in accordance with an exemplary embodiment of the present invention.

FIG. 5 is a flowchart of the determining step in accordance with an exemplary embodiment of the present invention.

FIG. 6 is a flowchart of the finding step in accordance with an exemplary embodiment of the present invention.

FIG. 7 is a flowchart of the rewriting step in accordance with an exemplary embodiment of the present invention.

FIG. 8 is a flowchart of the determining step in accordance with an exemplary embodiment of the present invention.

### DETAILED DESCRIPTION OF THE INVENTION

The present invention provides a method and system of creating at least one functional equivalent code segment of at least one original code segment of a computer software program with a lower energy footprint, configured to operate on at least one computer system. In an exemplary embodiment, the method and system include (1) creating at least one alternative code segment of the original code segment using at least one re-coding rule, (2) calculating a required energy consumption of the original code segment, (3) finding a required energy consumption of the alternative code segment, (4) comparing the required energy consumption of the original code segment with the required energy consumption of the alternative code segment, and (5) returning the functional equivalent code segment corresponding to the code segment with the minimum required energy consumption with respect to the results of the comparing.

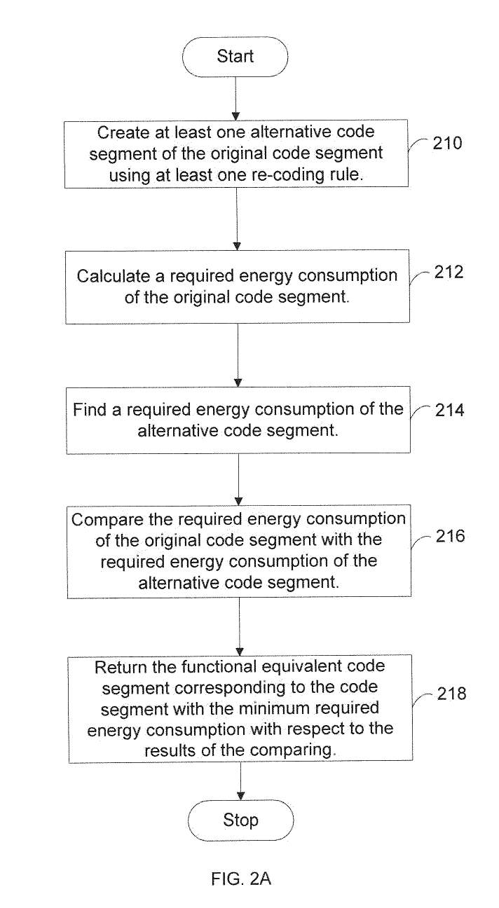

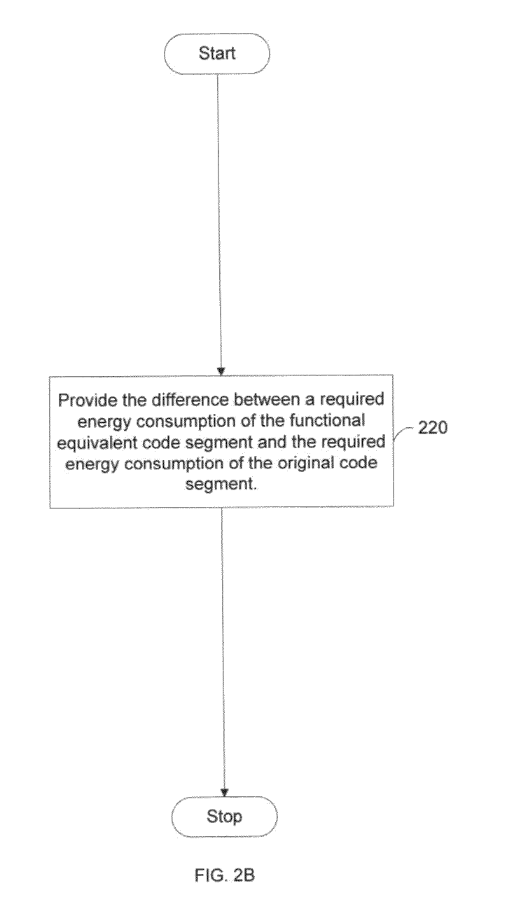

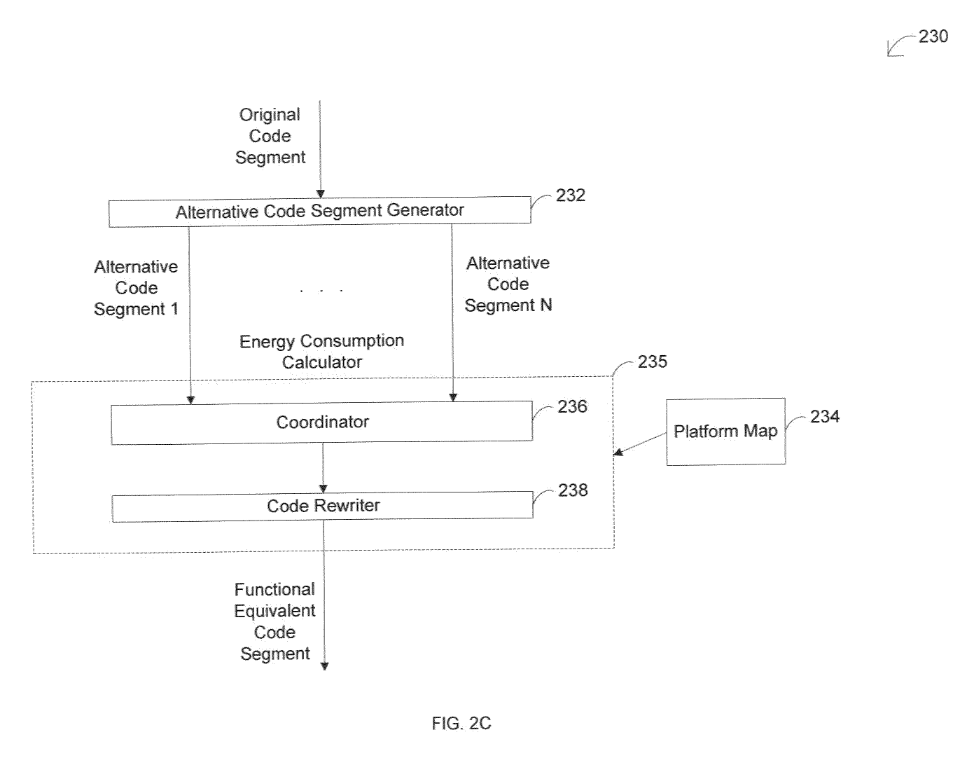

Referring to FIG. 2A, in an exemplary embodiment, the present invention includes a step 210 of creating at least one alternative code segment of the original code segment using at least one re-coding rule, a step 212 of calculating a required energy consumption of the original code segment, a step 214 of finding a required energy consumption of the alternative code segment, a step 216 of comparing the required energy consumption of the original code segment with the required energy consumption of the alternative code segment, and a step 218 of returning the functional equivalent code segment corresponding to the code segment with the minimum required energy consumption with respect to the results of the comparing. Referring to FIG. 2B, in an exemplary embodiment, the present invention further includes a step 220 of providing the difference between a required energy consumption of the functional equivalent code segment and the required energy consumption of the original code segment.

Referring to FIG. 2C, in an exemplary embodiment, the present invention includes an alternative code generator 232 and a energy consumption calculator 235. In an exemplary embodiment, energy consumption calculator 235 includes a coordinator 236 and a code rewriter 238. In an exemplary embodiment, alternative code segment generator 232 converts an original code segment into at least one alternative code segment (i.e., alternative code segment 1 to alternative code segment N). Energy consumption calculator 235 next coverts each of the alternative code segments into a functional equivalent code segment with a lower energy footprint by using a platform map 234. Specifically, coordinator 236 coordinates the alternative code segments (i.e., alternative code segment 1 to alternative code segment N) such that the each of alternative code segments is rewritten by code rewriter 238, in turn. Ultimately, energy consumption calculator 235 outputs a functional equivalent code segment.

### Calculating

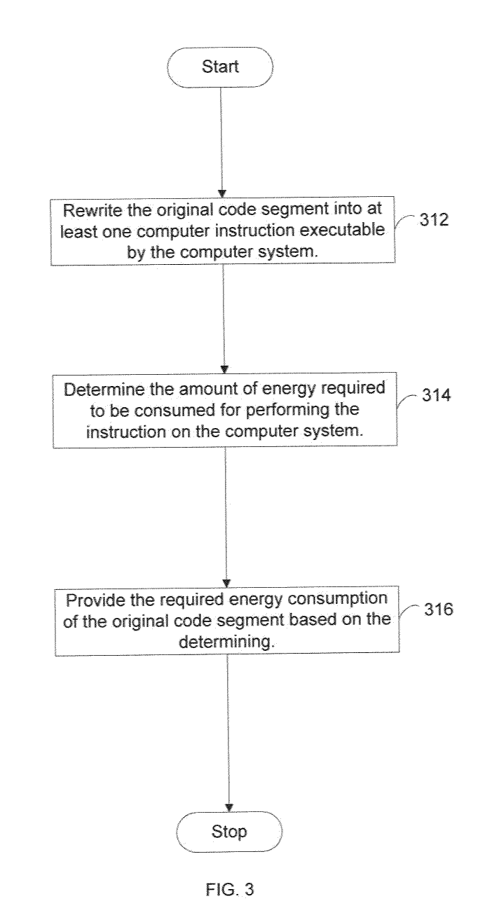

Referring to FIG. 3, in an exemplary embodiment, calculating step 212 includes a step 312 of rewriting the original code segment into at least one computer instruction executable by the computer system, a step 314 of determining the amount of energy required to be consumed for performing the instruction on the computer system, and a step 316 of providing the required energy consumption of the original code segment based on the determining. In an exemplary embodiment, calculating step 212 includes providing the required energy consumption of the original code segment based on real-time statistics of the operation of the computer system. For example, the real-time statistics may be sensor data from the computer system.

Rewriting

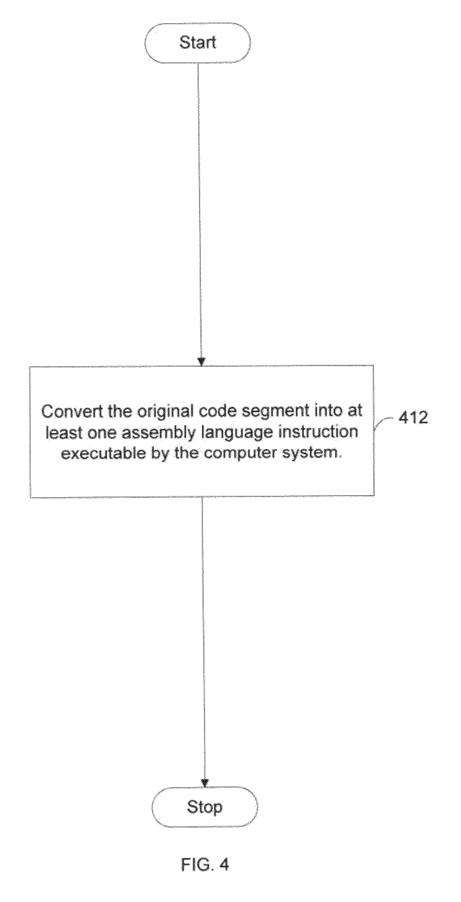

Referring to FIG. 4, in an exemplary embodiment, rewriting step 312 includes a step 412 of converting the original code segment into at least one assembly language instruction executable by the computer system. In an exemplary embodiment, converting step 412 includes using a programming language translator. Examples of such a translator are as follows: a BASIC interpreter, a C language compiler, a Lazy Assembler (LZASM), a Flat Assembler (FASM).

Determining

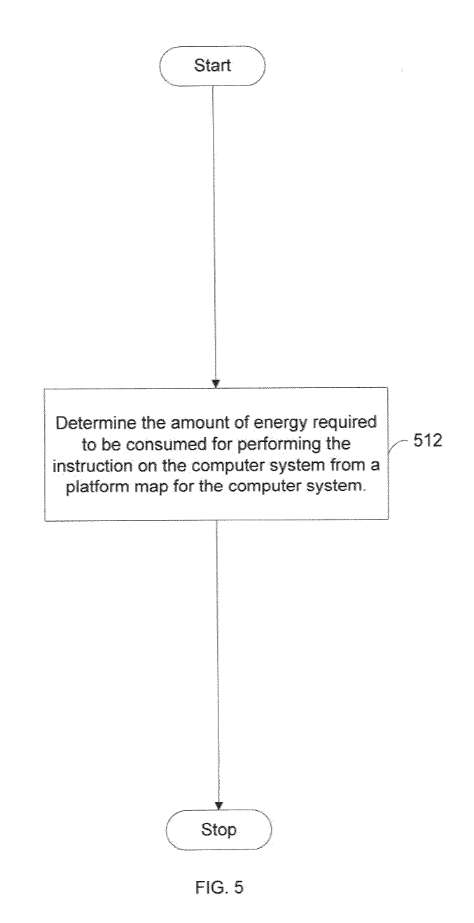

Referring to FIG. 5, in an exemplary embodiment, determining step 314 includes a step 512 of determining the amount of energy required to be consumed for performing the instruction on the computer system from a platform map for the computer system. In an exemplary embodiment, the platform map provides a mapping of instructions of the computer system and the energy consumption signatures/values of those instructions. In an exemplary embodiment, the platform map is populated from the analysis of the impact on the computer system of running on the computers system each of the instructions. In an exemplary embodiment, the platform map is provided by the manufacturer of the computer system. In an exemplary embodiment, the platform map is provided by analyzing the operation of the hardware components of the computer system.

### Finding

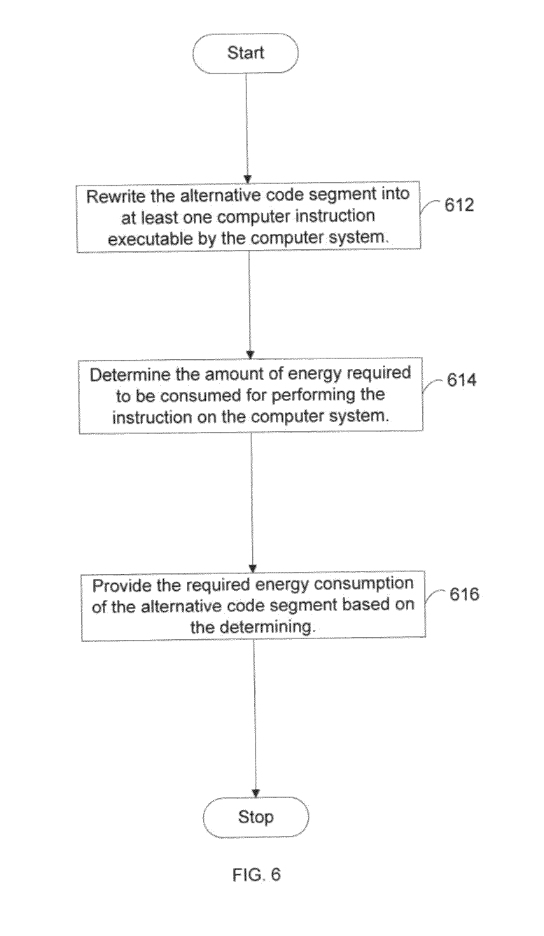

Referring to FIG. 6, in an exemplary embodiment, finding step 214 includes a step 612 of rewriting the alternative code segment into at least one computer instruction executable by the computer system, a step 614 of determining the amount of energy required to be consumed for performing the instruction on the computer system, and a step 616 of providing the required energy consumption of the alternative code segment based on the determining. In an exemplary embodiment, finding step 214 includes providing the required energy consumption of the alternative code segment based on real-time statistics of the operation of the computer system. For example, the real-time statistics may be sensor data from the computer system.

Rewriting

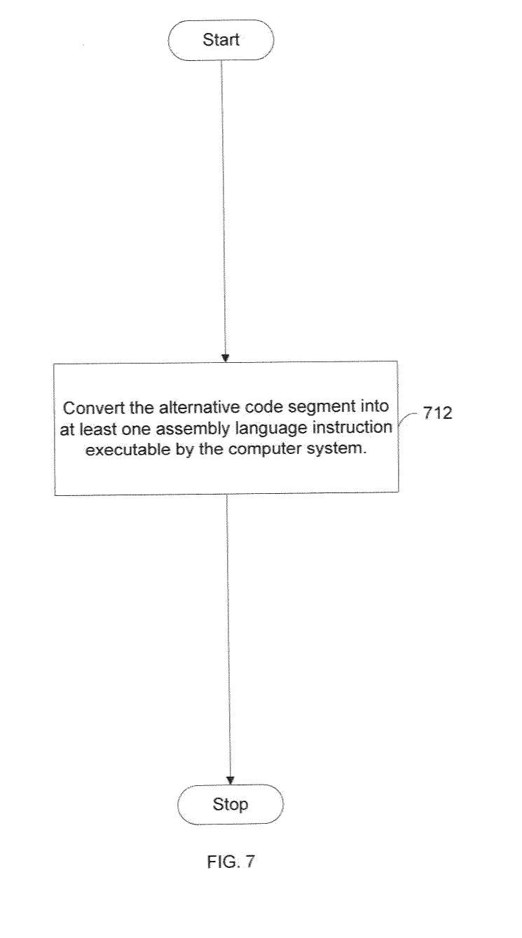

Referring to FIG. 7, in an exemplary embodiment, rewriting step 612 includes a step 712 of converting the alternative code segment into at least one assembly language instruction executable by the computer system. In an exemplary embodiment, converting step 712 includes using a programming language translator. Examples of such a translator are as follows: a BASIC interpreter, a C language compiler, a Lazy Assembler (LZASM), a Flat Assembler (FASM).

Determining

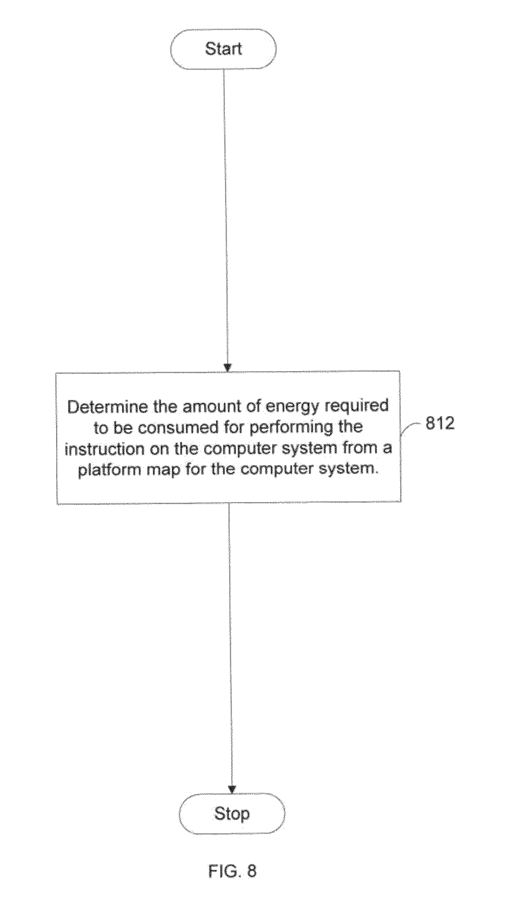

Referring to FIG. 8, in an exemplary embodiment, determining step 614 includes a step 812 of determining the amount of energy required to be consumed for performing the instruction on the computer system from a platform map for the computer system. In an exemplary embodiment, the platform map provides a mapping of instructions of the computer system and the energy consumption signatures/values of those instructions. In an exemplary embodiment, the platform map is populated from the analysis of the impact on the computer system of running on the computers system each of the instructions. In an exemplary embodiment, the platform map is provided by the manufacturer of the computer system. In an exemplary embodiment, the platform map is provided by analyzing the operation of the hardware components of the computer system.

### General

The present invention can take the form of an entirely hardware embodiment, an entirely software embodiment, or an embodiment containing both hardware and software elements. In an exemplary embodiment, the present invention is implemented in software, which includes but is not limited to firmware, resident software, and microcode.

Furthermore, the present invention can take the form of a computer program product accessible from a computer-usable or computer-readable medium providing program code for use by or in connection with a computer system or any instruction execution system. The computer program product includes the instructions that implement the method of the present invention. A computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

A computer system suitable for storing and/or executing program code includes at least one processor coupled directly or indirectly to memory elements through a system bus. The memory elements include local memory employed during actual execution of the program code, bulk storage, and cache memories that provide temporary storage of at least some program code to reduce the number of times code is retrieved from bulk storage during execution. Input/output (I/O) devices (including but not limited to keyboards, displays, pointing devices, etc.) can be coupled to the computer system either directly or through intervening I/O controllers. Network adapters may also be coupled to the computer system in order to enable the computer system to become coupled to other computer systems or remote printers or storage devices through intervening private or public networks. Modems, cable modems, and Ethernet cards are just a few of the currently available types of network adapters. The computer system can also include an operating system and a computer file-system.

### CONCLUSION

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

What is claimed is:

1. A processor-implemented method of creating at least one functional equivalent code segment of at least one original code segment of a computer software program with a lower energy footprint, configured to operate on at least one computer system, the method comprising:
creating at least one alternative code segment of the original code segment using at least one re-coding rule;
calculating a required energy consumption of the original code segment;
finding a required energy consumption of the alternative code segment;
comparing the required energy consumption of the original code segment with the required energy consumption of the alternative code segment; and
returning the functional equivalent code segment corresponding to the code segment with the minimum required energy consumption with respect to the results of the comparing.

2. The method of claim 1 further comprising providing the difference between a required energy consumption of the functional equivalent code segment and the required energy consumption of the original code segment.

3. The method of claim 1 wherein the calculating comprises:
rewriting the original code segment into at least one computer instruction executable by the computer system;
determining the amount of energy required to be consumed for performing the instruction on the computer system; and
providing the required energy consumption of the original code segment based on the determining.

4. The method of claim 3 wherein the rewriting comprises converting the original code segment into at least one assembly language instruction executable by the computer system.

5. The method of claim 3 wherein the determining comprises determining the amount of energy required to be consumed for performing the instruction on the computer system from a platform map for the computer system.

6. The method of claim 1 wherein the finding comprises:
rewriting the alternative code segment into at least one computer instruction executable by the computer system;
determining the amount of energy required to be consumed for performing the instruction on the computer system; and
providing the required energy consumption of the alternative code segment based on the determining.

7. The method of claim 6 wherein the rewriting comprises converting the alternative code segment into at least one assembly language instruction executable by the computer system.

8. The method of claim 6 wherein the determining comprises determining the amount of energy required to be consumed for performing the instruction on the computer system from a platform map for the computer system.

9. A system of creating at least one functional equivalent code segment of at least one original code segment of a computer software program with a lower energy footprint, configured to operate on at least one computer system, the system comprising:
a creating module configured to create at least one alternative code segment of the original code segment using at least one re-coding rule;
a calculating module configured to calculate a required energy consumption of the original code segment;
a finding module configured to find a required energy consumption of the alternative code segment;
a comparing module configured to compare the required energy consumption of the original code segment with the required energy consumption of the alternative code segment; and
a returning module configured to return the functional equivalent code segment corresponding to the code segment with the minimum required energy consumption with respect to the results of the comparing.

10. The system of claim 9 further comprising a providing module configured to provide the difference between a required energy consumption of the functional equivalent code segment and the required energy consumption of the original code segment.

11. The system of claim 9 wherein the calculating module comprises:
a rewriting module configured to rewrite the original code segment into at least one computer instruction executable by the computer system;
a determining module configured to determine the amount of energy required to be consumed for performing the instruction on the computer system; and
a providing module configured to provide the required energy consumption of the original code segment based on the determining.

12. The system of claim 11 wherein the rewriting module comprises a converting module configured to convert the original code segment into at least one assembly language instruction executable by the computer system.

13. The system of claim 11 wherein the determining module comprises a determining module configured to determine the amount of energy required to be consumed for performing the instruction on the computer system from a platform map for the computer system.

14. The system of claim 9 wherein the finding module comprises:
a rewriting module configured to rewrite the alternative code segment into at least one computer instruction executable by the computer system;
a determining module configured to determine the amount of energy required to be consumed for performing the instruction on the computer system; and
a providing module configured to provide the required energy consumption of the alternative code segment based on the determining.

15. The system of claim 14 wherein the rewriting module comprises a converting module configured to convert the alternative code segment into at least one assembly language instruction executable by the computer system.

16. The system of claim 14 wherein the determining module comprises a determining module configured to determine the amount of energy required to be consumed for performing the instruction on the computer system from a platform map for the computer system.

17. A computer program product usable with a programmable computer having readable program code embodied therein of creating at least one functional equivalent code segment of at least one original code segment of a computer software program with a lower energy footprint, configured to operate on at least one computer system, the computer program product comprising:
computer readable code for creating at least one alternative code segment of the original code segment using at least one re-coding rule;
computer readable code for calculating a required energy consumption of the original code segment;
computer readable code for finding a required energy consumption of the alternative code segment;
computer readable code for comparing the required energy consumption of the original code segment with the required energy consumption of the alternative code segment; and
computer readable code for returning the functional equivalent code segment corresponding to the code segment with the minimum required energy consumption with respect to the results of the comparing.

18. The computer program product of claim 17 further comprising computer readable code for providing the difference between a required energy consumption of the functional equivalent code segment and the required energy consumption of the original code segment.

19. The computer program product of claim 17 wherein the computer readable code for calculating comprises:
computer readable code for rewriting the original code segment into at least one computer instruction executable by the computer system;
computer readable code for determining the amount of energy required to be consumed for performing the instruction on the computer system; and
computer readable code for providing the required energy consumption of the original code segment based on the determining.

20. The computer program product of claim 19 wherein the computer readable code for rewriting comprises computer readable code for converting the original code segment into at least one assembly language instruction executable by the computer system.

21. The computer program product of claim 19 wherein the computer readable code for determining comprises computer readable code for determining the amount of energy required to be consumed for performing the instruction on the computer system from a platform map for the computer system.

22. The computer program product of claim 17 wherein the computer readable code for finding comprises:
computer readable code for rewriting the alternative code segment into at least one computer instruction executable by the computer system;
computer readable code for determining the amount of energy required to be consumed for performing the instruction on the computer system; and
computer readable code for providing the required energy consumption of the alternative code segment based on the determining.

23. The computer program product of claim 22 wherein the computer readable code for rewriting comprises computer readable code for converting the alternative code segment into at least one assembly language instruction executable by the computer system.

24. The computer program product of claim 22 wherein the computer readable code for determining comprises computer readable code for determining the amount of energy required to be consumed for performing the instruction on the computer system from a platform map for the computer system.
